(19) United States
(12) Patent Application Publication
(10) Pub. No.: US 2026/0138619 A1
(43) Pub. Date: May 21, 2026

(54) METHODS AND CAMERA MONITOR SYSTEMS FOR DETECTING UNEVEN TRAILER LOADING

(71) Applicant: Stoneridge Electronics AB, Solna (SE)

(72) Inventors: Banuprakash Murthy, Novi, MI (US); Vamsi Krishna Konka, Novi, MI (US); Girikrishna Talla, Novi, MI (US)

(21) Appl. No.: 18/953,260

(22) Filed: Nov. 20, 2024

(51) Int. Cl. B60W 40/13; B60R 11/04; B60W 50/14; G06T 7/73; G06V 10/75

(52) U.S. Cl. CPC B60W 40/13; B60R 11/04; B60W 50/14; G06T 7/74; G06V 10/75; B60W 2300/14; G06V 2201/08

(57) ABSTRACT

A method for a camera monitor system (CMS) includes utilizing a camera mounted to one of a tractor and a trailer of a commercial vehicle to record an image of the other of the tractor and the trailer; comparing an attribute of the other of the tractor and the trailer in the image to a reference attribute corresponding to a reference image; and, based on the attribute and the reference attribute differing by more than a predefined threshold, determining that the trailer is unevenly loaded, and providing a notification to an occupant of the commercial vehicle in response thereto. The comparing and providing a notification are performed by an electronic control unit of the CMS. A camera monitor system (CMS) is also disclosed.

### TECHNICAL FIELD

This disclosure relates to methods and camera monitor systems (CMS) for detecting uneven trailer loading.

### BACKGROUND

Vehicle camera systems for mirror replacement or for supplementing mirror views are utilized in commercial vehicles to enhance the ability of a vehicle operator to see a surrounding environment of the commercial vehicle. These systems are known as “camera monitor systems” (CMS), and they utilize one or more cameras mounted to a tractor of a commercial vehicle to provide an enhanced field of view to a vehicle operator of an area surrounding a trailer of the commercial vehicle. CMS may also include cameras in locations not typically associated with a mirror, such as a rear camera (e.g., a trailer camera) that records images of an area behind a vehicle, a camera that records an area in front of a vehicle, etc.

For a variety of reasons, a commercial vehicle may be unevenly loaded, such that the weight of cargo in the trailer is not evenly distributed. Uneven loading may lead to issues such as uneven tire wear and/or trailer swaying. Uneven loading may also make it easier for a trailer to rollover.

### SUMMARY

A method for a camera monitor system (CMS) according to an example embodiment of the present disclosure includes utilizing a camera mounted to one of a tractor and a trailer of a commercial vehicle to record an image of the other of the tractor and the trailer; comparing an attribute of the other of the tractor and the trailer in the image to a reference attribute corresponding to a reference image; and, based on the attribute and the reference attribute differing by more than a predefined threshold, determining that the trailer is unevenly loaded, and providing a notification to an occupant of the commercial vehicle in response thereto. The comparing and providing a notification are performed by an electronic control unit of the CMS.

In a further embodiment of the foregoing embodiment, the attribute includes an image area of the other of the tractor and the trailer.

In a further embodiment of any of the foregoing embodiments, the attribute includes a location or orientation of a feature of the other of the tractor and the trailer.

In a further embodiment of any of the foregoing embodiments, the camera is mounted to the trailer and is configured to record the image of the tractor.

In a further embodiment of any of the foregoing embodiments, the camera is mounted to the tractor and is configured to record the image of the trailer.

In a further embodiment of any of the foregoing embodiments, the determining that the trailer is unevenly loaded includes determining an area of the trailer that is overloaded.

In a further embodiment of any of the foregoing embodiments, the determining an area of the trailer that is overloaded includes determining that the trailer is overloaded towards a first lateral side of the trailer based on the comparing indicating that the trailer is leaning towards the first lateral side; and determining that the trailer is overloaded towards a second lateral side of the trailer, which is opposite the first lateral side, based on the comparing indicating that the trailer is leaning towards the second lateral side.

In a further embodiment of any of the foregoing embodiments, the camera has a field of view that includes an area above a fifth wheel coupling of the tractor, and the attribute corresponds to a graphical indicator on a front side of the trailer.

In a further embodiment of any of the foregoing embodiments, the attribute corresponds to a location of the graphical indicator. The determining an area of the trailer that is overloaded includes determining that the trailer is overloaded towards a front end of the trailer based on the graphical indicator being located lower in the image as compared to the reference image; and determining that the trailer is overloaded towards a rear end of the trailer based on the graphical indicator being located higher in the image as compared to the reference image.

In a further embodiment of any of the foregoing embodiments, the graphical indicator includes a pair of vertical lines that are spaced apart from each other, and the determining an area of the trailer that is overloaded includes determining that the trailer is overloaded towards a front end of the trailer based on the pair of vertical lines converging more closely towards a top of the image as compared to the reference image; and determining that the trailer is overloaded towards a rear end of the trailer based on the pair of vertical lines converging more closely towards a bottom of the image as compared to the reference image.

A CMS according to an example embodiment of the present disclosure includes a camera mounted to one of a tractor and a trailer of a commercial vehicle to record an image of the other of the tractor and the trailer and an electronic control unit (ECU) that includes processing circuitry. The processing circuitry is operatively connected to memory and is configured to perform a comparison of an attribute of the other of the tractor and the trailer in the image to a reference attribute corresponding to a reference image; and, based on the attribute and the reference attribute differing by more than a predefined threshold, make a determination that the trailer is unevenly loaded, and provide a notification to an occupant of the commercial vehicle in response thereto.

In a further embodiment of the foregoing embodiment, the attribute includes an image area of the other of the tractor and the trailer.

In a further embodiment of any of the foregoing embodiments, the attribute includes a location or orientation of a feature of the other of the tractor and the trailer.

In a further embodiment of any of the foregoing embodiments, the camera is mounted to the trailer and is configured to record the image of the tractor.

In a further embodiment of any of the foregoing embodiments, the camera is mounted to the tractor and is configured to record the image of the trailer.

In a further embodiment of any of the foregoing embodiments, the determination that the trailer is unevenly loaded includes a determination of an area of the trailer that is overloaded.

In a further embodiment of any of the foregoing embodiments, the determination that the trailer is unevenly overloaded includes a determination that the trailer is overloaded towards a first lateral side of the trailer based on the comparison indicating that the trailer is leaning towards the first lateral side; and a determination that the trailer is overloaded towards a second lateral side of the trailer, which is opposite the first lateral side, based on the comparison indicating that the trailer is leaning towards the second lateral side.

In a further embodiment of any of the foregoing embodiments, the camera has a field of view that includes an area above a fifth wheel coupling of the tractor, and the attribute corresponds to a graphical indicator on a front side of the trailer.

In a further embodiment of any of the foregoing embodiments, the attribute corresponds to a location of the graphical indicator. The determination of the area of the trailer that is overloaded includes a determination that the trailer is overloaded towards a front end of the trailer based on the graphical indicator being located lower in the image as compared to the reference image; and a determination that the trailer is overloaded towards a rear end of the trailer based on the graphical indicator being located higher in the image as compared to the reference image.

In a further embodiment of any of the foregoing embodiments, the graphical indicator includes a pair of vertical lines that are spaced apart from each other. The determination of the area of the trailer that is overloaded includes a determination that the trailer is overloaded towards a front end of the trailer based on the pair of vertical lines converging more closely towards a top of the image as compared to the reference image; and a determination that the trailer is overloaded towards a rear end of the trailer based on the pair of vertical lines converging more closely towards a bottom of the image as compared to the reference image.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

The disclosure can be further understood by reference to the following detailed description when considered in connection with the accompanying drawings wherein:

FIG. 1 is a schematic front view of a commercial vehicle with a camera monitor system (CMS) used to provide at least Class II and Class IV views.

FIG. 2 is a schematic birds-eye view of the commercial vehicle of FIG. 1 with a CMS providing Class II, Class IV, Class V, and Class VI views.

FIG. 3 is a schematic top view of an example vehicle cabin interior.

FIG. 4 is a schematic perspective view of the example vehicle cabin interior.

FIG. 5A is a schematic back view of an evenly-loaded commercial vehicle.

FIG. 5B is a schematic front view of the commercial vehicle of FIG. 5A.

FIG. 6A is a schematic view of a back of a commercial vehicle where the trailer is not evenly-loaded and is tilted toward a first side of the vehicle.

FIG. 6B is a schematic view of a front of the commercial vehicle of FIG. 6A.

FIG. 7A is a schematic view of a back of a commercial vehicle where the trailer is not evenly-loaded and is tilted toward a second side of the vehicle.

FIG. 7B is a schematic view of a front of the commercial vehicle of FIG. 7A.

FIG. 8A is a schematic view of a graphical indicator on the front of a trailer when the trailer is evenly-loaded.

FIG. 8B is a schematic view of the graphical indicator of FIG. 8A when the trailer is not evenly-loaded, and is tilted forwards towards a front end of the trailer.

FIG. 8C is a schematic view of the graphical indicator of FIG. 8A when the trailer is not evenly-loaded, and is tilted forwards towards a rear end of the trailer.

FIG. 9 is a flowchart of an example method for a CMS.

FIG. 10 is a schematic view of an example CMS image.

FIG. 11 is a schematic view of another example CMS image.

### DETAILED DESCRIPTION

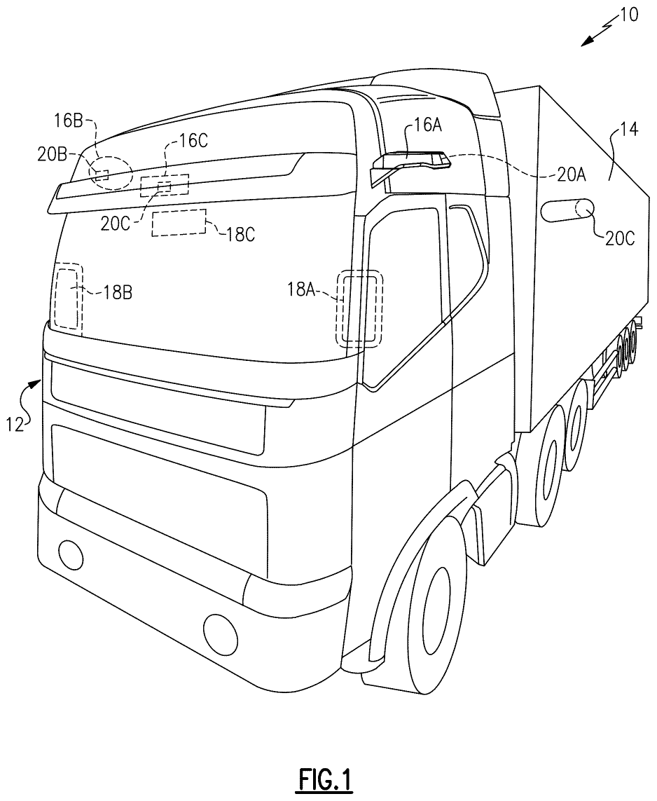

Schematic views of a commercial vehicle 10 are illustrated in FIGS. 1-4. The commercial vehicle 10 includes a vehicle cab or “tractor” 12 for pulling a trailer 14, where the trailer 14 pivots with respect to the tractor 12 during turns. Although the commercial vehicle 10 is depicted as a commercial truck with a single trailer in this disclosure, it is understood that other commercial vehicle configurations may be used (e.g., different types or quantities of trailers).

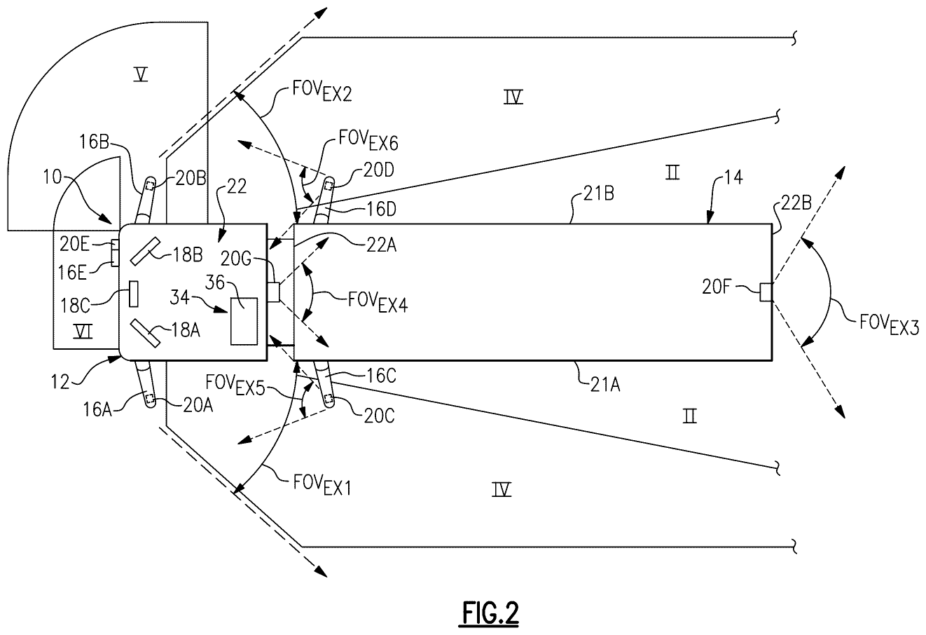

A pair of camera arms 16A-B include a respective base that is secured to the tractor 12, and a pair of camera arms 16C-D include a respective base that is secured to the trailer 14. One, all, or a subset of the camera arms 16A-D may articulate relative to their base between a retracted position and an extended position. Each camera arm 16A-D includes at least one respective camera 20A-D on or within the arm. The cameras 20A-B are mounted to the tractor 12 and are configured to record images of the trailer 14, and the cameras 20C-D are mounted to the trailer 14 and are configured to record images of the tractor 12. When the commercial vehicle 10 is driving straight as in FIG. 2), camera 20A provides a view of along side 21A of the trailer 14, and camera 20B provides a view along side 21B of the trailer.

The cameras 20A-B respectively provide exterior fields of view FOV_{EX1}, FOV_{EX2} that each include at least one of Class II and Class IV views (see FIG. 2), which are legally prescribed views in the commercial trucking industry. The cameras 20A-B are “rearward facing” in that their respective fields of view FOV_{EX1} and FOV_{EX2} at least partially face towards a rear of the commercial vehicle 10. The cameras 20C-D have respective fields of view FOV_{EX3} and FOV_{EX4} that are “forward facing” in that the fields of view FOV_{EX3} and FOV_{EX4} at least partially face towards a front of the commercial vehicle 10.

As shown in FIG. 2, the trailer 14 has a first side 21A (commonly referred to as a “driver's side”) and an opposite second side 21B (commonly referred to as a “passenger side.” The trailer 14 also has a front end 22A that faces towards the tractor 12, and has a rear end 22B.

The Class II view on a given side of the commercial vehicle 10 is a subset of the Class IV view of the same side of the commercial vehicle 10. Multiple cameras also may be used in each camera arm 16A-B to provide these views, if desired. Class II (narrow) and Class IV (wide angle) views are defined in European R46 legislation, for example, and the United States and other countries have similar drive visibility requirements for commercial trucks.

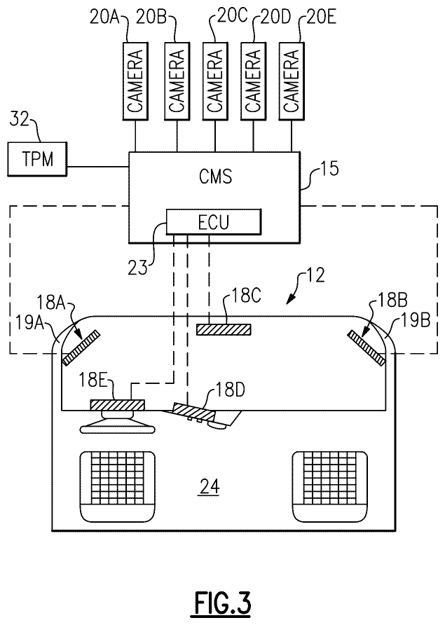

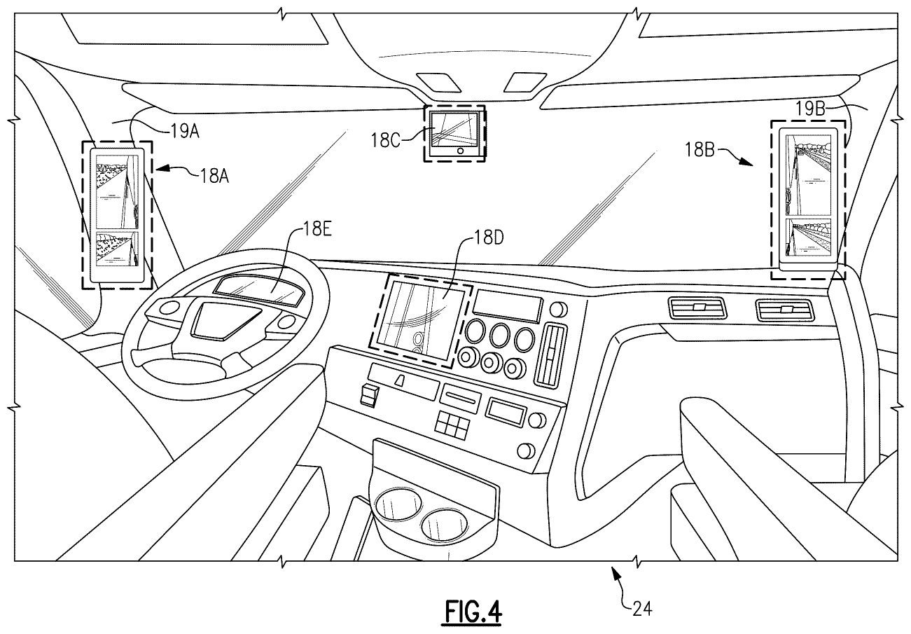

Each camera arm 16A-16D may also provide a housing that encloses electronics, e.g., a controller, that are configured to provide various features of a camera monitor system (“CMS”) 15 (see FIG. 4). The camera arms 16A-B may be mounted either at a roof-mount location over the cab door (as shown), or on a door-mounted bracket or station, for example. Similarly, the camera arms 16C-D may be mounted at a roof-mount location of the trailer 14 or a lower location (as shown in FIG. 1), for example.

If video of Class V and/or Class VI views is also desired, a camera housing 16E and camera 20E may be arranged at or near the front of the commercial vehicle 10 to provide those views (FIG. 2).

A backup camera 20F provides a field of view FOV_{EX5} of rear area 28C behind the commercial vehicle 10, which overlaps the fields of view FOV_{EX1}, FOV_{EX2}, FOV_{EX3}, FOV_{EX4}. The backup camera 20F may be mounted at a top/centerline of the trailer, at a bumper/bed level of the trailer, or at a top-corner of the back of the trailer, for example.

Alternatively, or in addition to the rear trailer camera, a “fifth wheel camera”20G may be provided that is mounted to a rear of the tractor 12 and that provides a field of view FOV_{EX6} which depicts a fifth wheel coupling of the tractor 12, and which, when the trailer 14 is disconnected from the cab 12, also overlaps the fields of view FOV_{EX1}, FOV_{EX2}. The fifth wheel camera 20G may be mounted anywhere between the lateral plane of the fifth wheel fixture and the top/roof edge of the tractor, for example. The cameras 20A-G are part of the CMS 15.

FIG. 3 is a schematic top view of an example cabin interior 24 of the tractor 12, and FIG. 4 is a schematic perspective view of the example cabin interior 24. Referring now to FIGS. 3-4 with continued reference to FIGS. 1-2, electronic displays 18A-E (e.g., which may be video displays, such as LCD displays) and cameras 20A-G are shown. The various electronic displays 18A-E and cameras 20A-G are part of the CMS 15, and therefore act as CMS displays and CMS cameras. As used herein, a “CMS camera” 20 is a camera configured to record images of an environment surrounding commercial vehicle 10, and a “CMS display” 18 is an electronic display (e.g., an LCD) that is configured to display image feeds from those cameras.

The CMS 15 includes a CMS electronic control unit (ECU) 23 that acts as a controller and includes processing circuitry that supports operation of the CMS 15. The CMS ECU 23 is operatively connected to memory (which may include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). The processing circuitry may include one or more microprocessors, microcontrollers, application specific integrated circuits (ASICs), or the like. A tire pressure monitoring system 32 is in communication with the ECU 23, and informs the ECU 23 when one or more tires of the commercial vehicle 10 are underinflated.

The CMS displays 18A-B are arranged on each of the driver and passenger sides within the tractor 12 on or near the A-pillars 19A-B to display, e.g., Class II and Class IV views on their respective sides of the commercial vehicle 10, which provide rearward facing side views along the commercial vehicle 10 that are captured by the exterior cameras 20A-B.

As discussed above, if video of Class V and Class VI views is also desired, the camera housing 16E and camera 20E may be arranged at or near the front of the commercial vehicle 10 to provide those views (FIG. 2). In the example of FIG. 4, additional displays 18C-E are provided. Display 18C is arranged in the vehicle cabin interior 24 near the top center of the windshield may be used to display the Class V and Class VI views, which are toward the front of the commercial vehicle 10, or a backup camera view (from camera 20F or 20G) to the driver. Display 18D is provided in a center console area of the vehicle cabin interior 24, and may be used as a backup display or for other purposes, such as navigation, infotainment, etc. Display 18E may be part of an instrument cluster, for example, and may be used as a backup display.

If desired, one or more of the camera arms 16A-D may include conventional mirrors integrated with them as well, although the CMS 15 may be used to entirely replace mirrors. In additional examples, each side can include multiple camera arms, with each arm housing one or more cameras and/or mirrors.

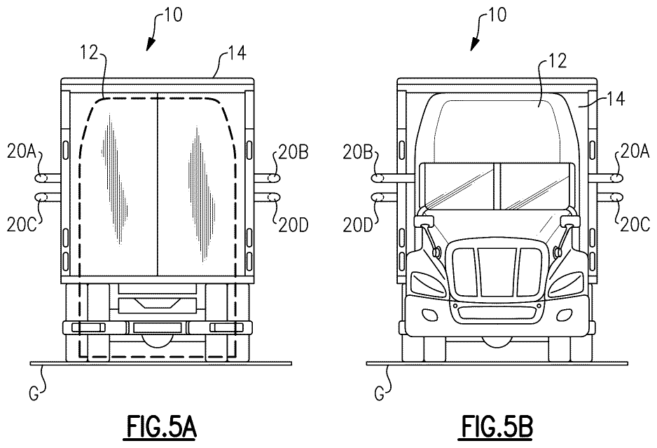

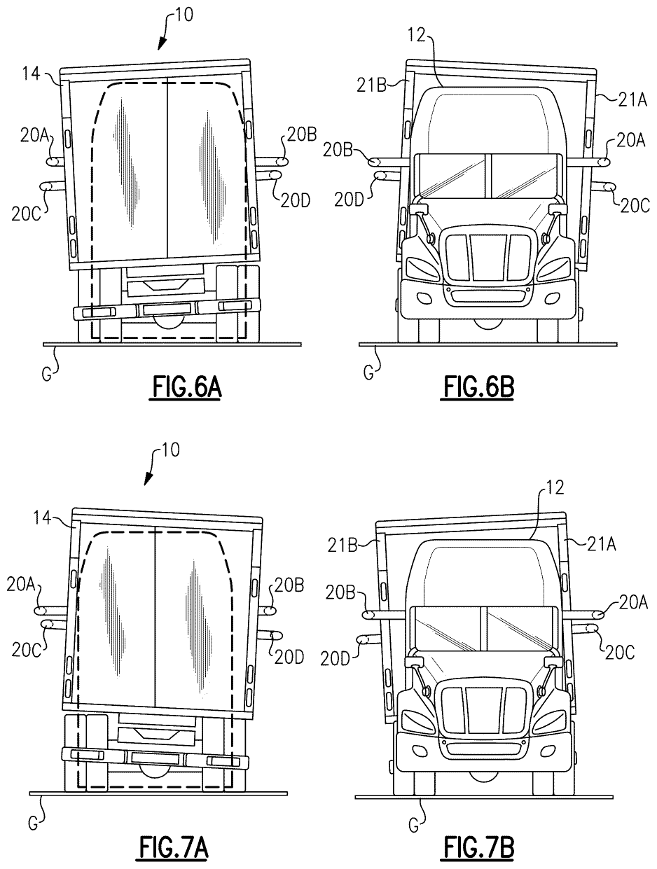

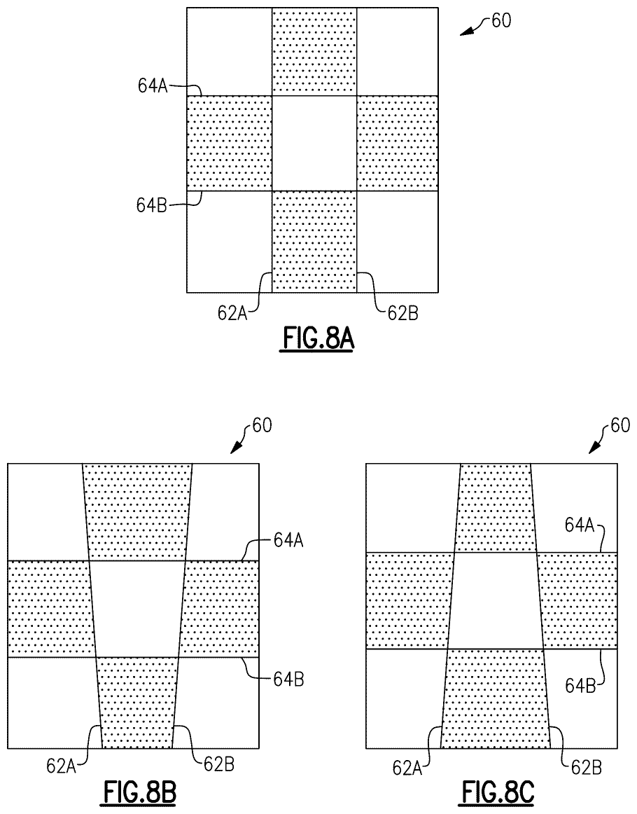

FIG. 5A is a schematic back view of the commercial vehicle 10 when it is evenly loaded on a non-inclined ground plane G, and FIG. 5B provides a schematic front view of the same commercial vehicle 10, which includes the tractor 12 and the trailer 14. In FIG. 5A (and FIGS. 6A and 7A), the dotted line represents the outline of the tractor 12, which is in front of, but hidden by, the trailer 14. Although the tractor 12 is depicted slightly differently in FIGS. 5A-B (and 6A-B and 7A-B) as compared to FIGS. 1-2, the same reference numerals will be used that were used above. The cameras 20A-B are mounted to the tractor 12 and provide respective views of the trailer 14, and the cameras 20C-D are mounted to the trailer 14 and provide respective views of the tractor 12. Because the trailer 14 is evenly loaded, it is not tilted towards either of its opposing sides 21A-B or towards either of its opposing ends 22A-B.

FIG. 6A is a schematic back view of the commercial vehicle 10 when the trailer 14 is not evenly-loaded, and is overloaded towards the side 21A, and as a result is tilted towards the side 21A. FIG. 6B is a schematic front view of the same scenario. As used herein, “overloaded” does not necessarily mean that the trailer 14 has exceeded its weight capacity, but rather means that the trailer is loaded more heavily in the “overloaded” area than other areas of the trailer 14, thereby causing the trailer to tilt.

FIG. 7A is a schematic back view of the commercial vehicle 10 when the trailer 14 is not evenly-loaded, and is overloaded towards the side 21B, and as a result is tilted towards the side 21B. FIG. 7B is a schematic front view of the same scenario. As will be described below, images from the cameras 20A-D may be used to detect the lateral trailer tilting conditions shown in FIGS. 6A-B and 7A-B.

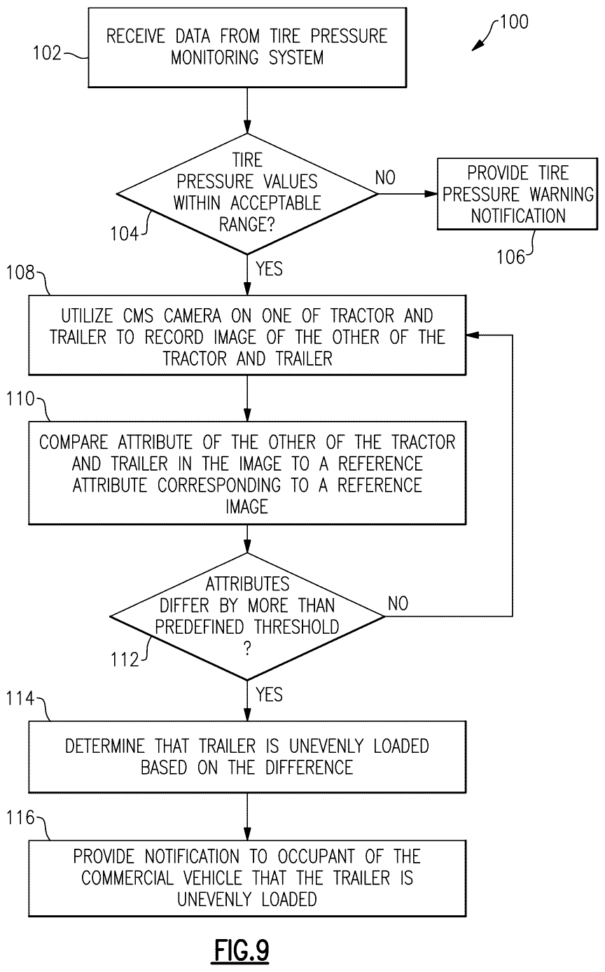

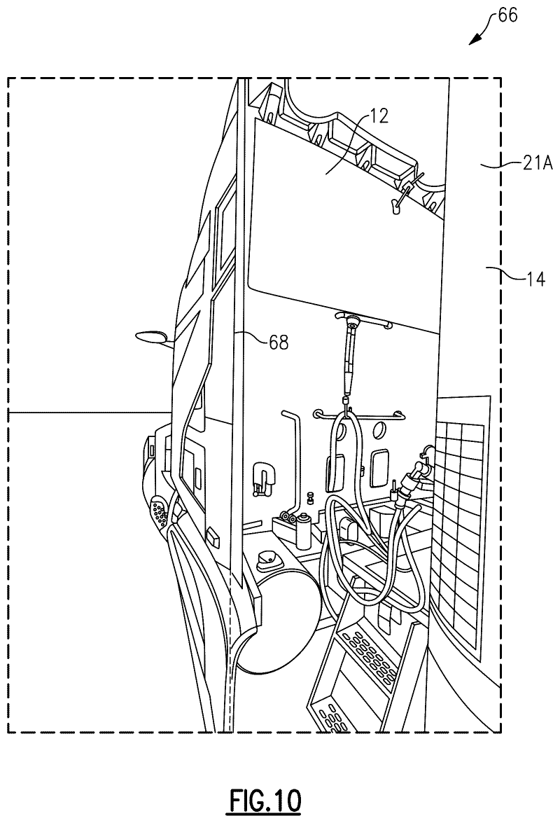

FIG. 8A is an example of a graphical indicator 60 that may be featured on the front end 22A of the commercial vehicle 10, and that may be used to detect when the trailer 14 is tilted forwards (towards end 22A) or backwards (towards end 22B). The graphical indicator 60 is depicted in FIG. 8A as it would appear to camera 20G when the trailer 14 is evenly loaded. Thus, as depicted in FIG. 8A, the graphical indicator 60 would be suitable as a reference image, or as a portion of a reference image.

As shown, the graphical indicator 60 includes a checkerboard pattern that includes a pair of vertical lines 62A-B and a pair of horizontal lines 64A-B. Although the vertical lines 62A-B are completely vertical, with no horizontal aspect, in FIG. 8A, (i.e., they are 90° with respect to the horizontal lines 64A-B), it is understood that other graphical indicators 60 and/or other lines could be used (e.g., having an angle of 45-89° from being completely horizontal).

FIG. 8B is a schematic view an image depicting how the graphical indicator 60 may appear to camera 20G when the trailer 14 is not evenly-loaded, but rather is overloaded towards the front end 22A of the trailer 14. As shown in FIG. 8B, the lines 62A-B converge more closely towards a bottom of the image, indicating that the trailer 14 has tilted forwards towards end 22A. Another way this could be detected could be detecting that the graphic indicator 60 is located lower in the image than in the reference image (which may depict the graphical indicator 60 as shown in FIG. 8A).

FIG. 8C is a schematic view an image depicting how the graphical indicator 60 may appear to camera 20G when the trailer 14 is not evenly-loaded, but rather is overloaded towards the rear end 22B of the trailer 14. As shown in FIG. 8C, the lines 62A-B converge more closely towards a top of the image, indicating that the trailer 14 has tilted backwards. Another way this could be detected could be detecting that the graphic indicator 60 is located higher in the image than in the reference image (which may depict the graphical indicator 60 as shown in FIG. 8A).

FIG. 9 is a flowchart of an example method 100 for a CMS 15 for detecting uneven trailer loading. The method 100 may be performed by the ECU 23, for example.

Data is received from a tire pressure monitoring system 32 (step 102), and a determination is made of whether the received tire pressure values are within an acceptable range or whether one or more of the tires are underinflated (step 104).

If the tire pressure values are not within an acceptable range (a “no” to step 104), a tire pressure warning notification is provided (step 106). Steps 102-104 may be useful to avoid false positive detection of uneven trailer loading which is not actually due to uneven loading but is instead due to tire underinflation.

However, if the tire pressure values are within an acceptable range (a “yes” to step 104), the method proceeds to step 108.

A CMS camera 20 on one of the tractor 12 and the trailer is utilized to record an image of the other of the tractor 12 and the trailer 14 (step 108). Thus, an image recorded by camera 20A or 20B would depict the trailer 14, whereas an image recorded by the camera 20C or 20D would depict the tractor 12.

An attribute of the other of the tractor 12 and the trailer 14 is compared to a reference attribute corresponding to a reference image (step 110). The reference image represents a condition where the trailer 14 is evenly loaded (or is within a margin of error of being evenly loaded), corresponding to FIGS. 5A-B.

If the attribute and the reference attribute differ by more than a predefined threshold (a “yes” to block 112), the a determination is made that the trailer 14 is unevenly loaded based on the difference (step 114), and a notification is provided in response thereto (step 116) to notify an occupant of the vehicle that the trailer 14 is unevenly loaded.

Otherwise, if the attribute of the image and the attribute of the reference image do not differ by more than the predefined threshold (a “no” to block 112), the method proceeds back to step 108.

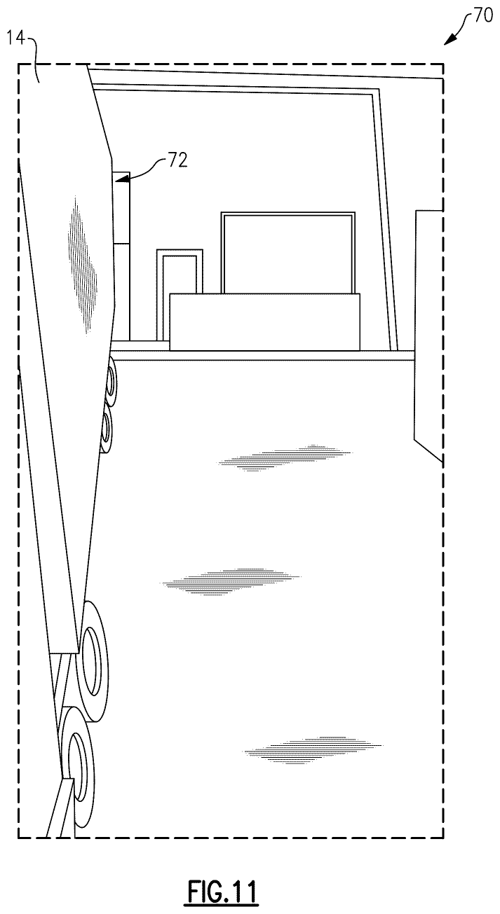

FIG. 10 depicts an example image 66 taken by camera 20C, which depicts the tractor 12, and FIG. 11 illustrates an example image 70 recorded by camera 20A, which depicts the trailer 14. The images 66, 70 will be used to explain some example image attributes that could be utilized in step 110 of the method 100.

In one or more embodiments, the attribute of the CMS image of step 110 includes an image area of said “other of the tractor and the trailer” of step 108 (e.g., the tractor 12 in the image 66 of FIG. 10 or the trailer 14 in the image 70 of FIG. 11), and the “reference attribute” of the reference image corresponds to the image area of said other of the tractor 12 and the trailer 14 in the reference image. In this example, the predefined threshold of step 112 is an image area threshold. Image area may be measured as a pixel count, for example. If the trailer 14 is overloaded to side 21A, the trailer 14 will tilt towards side 21A (as depicted in FIGS. 6A-B). In this scenario, less of the tractor 12 will be visible in the image 66 as compared to a reference image before the uneven loading, and correspondingly an image area (e.g., a number of pixels) that depicts the tractor 12 in the image 66 will be reduced. In this same scenario, more of the trailer 14 will be visible in the image 70 as compared to a reference image before the uneven loading, and correspondingly an image area (e.g., a number of pixels) that depicts the trailer 14 in the image 70 will increase.

Conversely, if the trailer 14 is overloaded to side 21B, the trailer 14 will tilt towards side 21B (as depicted in FIGS. 7A-B). In this scenario, more of the tractor 12 will be visible in the image 66 as compared to a reference image before the uneven loading, and correspondingly an image area (e.g., a number of pixels) that depicts the tractor 12 in the image 66 will increase. In this same scenario, less of the trailer 14 will be visible in the image 70 as compared to a reference image before the uneven loading, and correspondingly an image area (e.g., a number of pixels) that depicts the trailer 14 in the image 70 will reduce.

In one or more embodiments, the attribute in the CMS image includes a location or orientation of a feature of the other of the tractor and the trailer, and the “reference attribute” of the reference image corresponds to the location or orientation of the feature in the reference image. As shown in FIG. 10, the tractor 12 has an edge 68, and as shown in FIG. 11, the trailer has an edge 72. As the trailer 14 tilts, the location of the edges 68, 72 will move, and an angle of the edges 68, 72 with respect to a portion of the image 66, 70 (e.g., a bottom edge of the images) will also move. In one or more embodiments, the method 100 considers movement / orientation of features such as the edges 68, 72.

Thus, in one or more embodiments, the determining that the trailer 14 is unevenly loaded in step 114 includes determining an area of the trailer 14 that is overloaded (e.g., towards side 21A, towards side 21B, toward front end 22A, or towards rear end 22B). In one or more embodiments, this includes determining that the trailer 14 is overloaded towards a first lateral side of the trailer (side 21A) based on the comparing indicating that the trailer 14 is leaning towards the first lateral side; and determining that the trailer 14 is overloaded towards a second lateral side of the trailer (side 21B), which is opposite the first lateral side, based on the comparison of step 110 indicating that the trailer 14 is leaning towards the second lateral side.

In one or more embodiments, the method 100 utilizes the fifth wheel camera 20G to record images of a graphical indicator 60 (such as the graphical indicator 60 shown in FIGS. 8A-C), and the “attribute” that is analyzed in step 110 corresponds to the graphical indicator 60.

In one or more embodiments, the attribute corresponds to a location of the graphical indicator 60, and determining the an area of the trailer that is overloaded includes:
determining that the trailer 14 is overloaded towards the front end 22A of the trailer 14 based on the graphical indicator being located lower in the image as compared to the reference image; and determining that the trailer 14 is overloaded towards the rear end 22B of the trailer 14 based on the graphical indicator 60 being located higher in the image as compared to the reference image.

In one or more embodiments, the graphical indicator includes a pair of vertical lines that are spaced apart from each other (e.g., vertical liens 62A-B), and determining the area of the trailer 14 that is overloaded includes: determining that the trailer 14 is overloaded towards the front end 22A of the trailer 14 based on the pair of vertical lines converging more closely towards a top of the image as compared to the reference image; and determining that the trailer 14 is overloaded towards a rear end 22B of the trailer 14 based on the pair of vertical lines converging more closely towards a bottom of the image as compared to the reference image.

Although example embodiments have been disclosed, a worker of ordinary skill in this art would recognize that certain modifications would come within the scope of the claims. For that reason, the following claims should be studied to determine their true scope and content.

What is claimed is:

1. A method for a camera monitor system (CMS), comprising:
utilizing a camera mounted to one of a tractor and a trailer of a commercial vehicle to record an image of the other of the tractor and the trailer;
comparing an attribute of said other of the tractor and the trailer in the image to a reference attribute corresponding to a reference image; and
based on the attribute and the reference attribute differing by more than a predefined threshold, determining that the trailer is unevenly loaded, and providing a notification to an occupant of the commercial vehicle in response thereto;
wherein said comparing and providing a notification are performed by an electronic control unit of the CMS.

2. The method of claim 1, wherein the attribute comprises an image area of said other of the tractor and the trailer.

3. The method of claim 1, wherein the attribute comprises a location or orientation of a feature of said other of the tractor and the trailer.

4. The method of claim 1, wherein the camera is mounted to the trailer and is configured to record the image of the tractor.

5. The method of claim 1, wherein the camera is mounted to the tractor and is configured to record the image of the trailer.

6. The method of claim 1, wherein:
said determining that the trailer is unevenly loaded comprises determining an area of the trailer that is overloaded.

7. The method of claim 6, wherein said determining an area of the trailer that is overloaded comprises:
determining that the trailer is overloaded towards a first lateral side of the trailer based on the comparing indicating that the trailer is leaning towards the first lateral side; and
determining that the trailer is overloaded towards a second lateral side of the trailer, which is opposite the first lateral side, based on the comparing indicating that the trailer is leaning towards the second lateral side.

8. The method of claim 6, wherein:
the camera has a field of view that includes an area above a fifth wheel coupling of the tractor; and
the attribute corresponds to a graphical indicator on a front side of the trailer.

9. The method of claim 8, wherein:
the attribute corresponds to a location of the graphical indicator; and
said determining an area of the trailer that is overloaded comprises:
determining that the trailer is overloaded towards a front end of the trailer based on the graphical indicator being located lower in the image as compared to the reference image; and
determining that the trailer is overloaded towards a rear end of the trailer based on the graphical indicator being located higher in the image as compared to the reference image.

10. The method of claim 8, wherein:
the graphical indicator includes a pair of vertical lines that are spaced apart from each other; and
said determining an area of the trailer that is overloaded comprises:
determining that the trailer is overloaded towards a front end of the trailer based on the pair of vertical lines converging more closely towards a top of the image as compared to the reference image; and
determining that the trailer is overloaded towards a rear end of the trailer based on the pair of vertical lines converging more closely towards a bottom of the image as compared to the reference image.

11. A camera monitor system (CMS), comprising:
a camera mounted to one of a tractor and a trailer of a commercial vehicle to record an image of the other of the tractor and the trailer; and
an electronic control unit (ECU) that includes processing circuitry that is operatively connected to memory and is configured to:
perform a comparison of an attribute of said other of the tractor and the trailer in the image to a reference attribute corresponding to a reference image; and
based on the attribute and the reference attribute differing by more than a predefined threshold, make a determination that the trailer is unevenly loaded, and provide a notification to an occupant of the commercial vehicle in response thereto.

12. The CMS of claim 11, wherein the attribute comprises an image area of said other of the tractor and the trailer.

13. The CMS of claim 11, wherein the attribute comprises a location or orientation of a feature of said other of the tractor and the trailer.

14. The CMS of claim 11, wherein the camera is mounted to the trailer and is configured to record the image of the tractor.

15. The CMS of claim 11, wherein the camera is mounted to the tractor and is configured to record the image of the trailer.

16. The CMS of claim 11, wherein the determination that the trailer is unevenly loaded comprises a determination of an area of the trailer that is overloaded.

17. The CMS of claim 16, wherein to the determination that the trailer is unevenly overloaded comprises:
a determination that the trailer is overloaded towards a first lateral side of the trailer based on the comparison indicating that the trailer is leaning towards the first lateral side; and
a determination that the trailer is overloaded towards a second lateral side of the trailer, which is opposite the first lateral side, based on the comparison indicating that the trailer is leaning towards the second lateral side.

18. The CMS of claim 16, wherein:
the camera has a field of view that includes an area above a fifth wheel coupling of the tractor; and
the attribute corresponds to a graphical indicator on a front side of the trailer.

19. The CMS of claim 18, wherein:
the attribute corresponds to a location of the graphical indicator; and
the determination of the area of the trailer that is overloaded comprises:
a determination that the trailer is overloaded towards a front end of the trailer based on the graphical indicator being located lower in the image as compared to the reference image; and
a determination that the trailer is overloaded towards a rear end of the trailer based on the graphical indicator being located higher in the image as compared to the reference image.

20. The CMS of claim 18, wherein:
the graphical indicator includes a pair of vertical lines that are spaced apart from each other; and
the determination of the area of the trailer that is overloaded comprises:
a determination that the trailer is overloaded towards a front end of the trailer based on the pair of vertical lines converging more closely towards a top of the image as compared to the reference image; and
a determination that the trailer is overloaded towards a rear end of the trailer based on the pair of vertical lines converging more closely towards a bottom of the image as compared to the reference image.
